(19) United States
(12) Patent Application Publication
(10) Pub. No.: US 2015/0147569 A1
(43) Pub. Date: May 28, 2015

(54) THERMO-REGULATED FIBER AND PREPARATION METHOD THEREOF

(71) Applicant: TIANJIN POLYTECHNIC UNIVERSITY, Tianjin (CN)

(72) Inventors: Xing Xiang Zhang, Tianjin (CN); Jie Yun Meng, Tianjin (CN); Xiao Fen Tang, Tianjin (CN); Hai Feng Shi, Tianjin (CN)

(21) Appl. No.: 14/412,184

(22) PCT Filed: Mar. 21, 2013
(86) PCT No.: PCT/IB2013/000437

§ 371 Date: Dec. 30, 2014

(30) Foreign Application Priority Data
Jul. 3, 2012 (CN) 201210227516.0

(51) Int. Cl. D01F 8/16; B29C 47/00; D01F 8/14; D01F 8/08; D01F 8/06; D01F 8/12

(52) U.S. Cl. CPC D01F 8/16; D01F 8/06; D01F 8/12; D01F 8/14; D01F 8/08; B29C 47/0014; D10B 2321/021; D10B 2321/041; D10B 2321/10; D10B 2331/02; D10B 2331/04; B29K 2067/04
USPC 428/373; 264/13

(57) ABSTRACT

The present invention provides a thermo-regulated fiber and a preparation method thereof by using a new polymeric phase-change material and adopting a new fiber preparation method, and the resulting thermo-regulated fiber has good thermo-regulating properties and a good thermal stability. The thermo-regulated fiber has a composite structure, and the cross-sectional structure is an sea-island type or a concentric sheath/core type, characterised in that the polymeric phase-change material is a polyethylene glycol n-alkyl ether (structural formula: H(OCH₂CH₂)ₘOCₙH2ₙ₊₁), where the repeating unit number m of the ethylene glycol is 1 to 100, the number n of carbon atoms in the n-alkyl is 11 to 30. The present invention further relates to a preparation method of a thermo-regulated fiber which includes one of the following processes: (1) A melt composite spinning process; (2) Solution composite spinning process; (3) Electrostatic solution composite spinning process. Further, the present invention is characterised as follows: (1) a new polymeric phase-change material polyethylene glycol n-alkyl ether is used; (2) Component A of the thermo-regulated fiber may form a continuous crystallization region; (3) The thermo-regulated fiber can be prepared in various forms by many preparation methods such as melt composite spinning, solution composite spinning and solution static composite spinning.

### BACKGROUND

1. Technical Field

The present invention relates to a functional fiber technology, and more particularly to a thermo-regulated fiber having heat absorption, storage and release functions and preparation method thereof.

2. Related Art

Thermo-regulated fibers is a type of fibers having heat absorption and release functions obtained by implanting a phase-change material in a fiber or coating a phase-change material on a fiber surface. The following three methods are used to implant a phase-change material in a fiber. (1) Phase-change material microcapsules (core-shell structure microspheres having a diameter of 1 to 1,000 micrometers using a phase-change material as the core) are prepared from a phase-change material, then added into a polymer solution or melt, and to obtain a fiber by a conventional or non-conventional process. For example, U.S. Pat. No. 4,756,958 disclosed a technology of mixing phase-change material microcapsules in a polymer to produce a fiber with reversible thermal storage properties. In the spinning procedure, the diameter of the microcapsules is required to be 3 micrometers and less. The researches (see Journal of Colloid and Interface Science, 2005, 281(2): 299-306) conducted by the applicant of the present invention show that, when the particle diameter of the phase-change material microcapsules is less than 4.6 micrometers, the phenomenon of super-cooling crystallization (the crystallization temperature of the microencapsulated phase-change material is significantly lower than the crystallization temperature of the phase-change material) would become very significant. Sometimes, the super-cooling crystallization temperature is upto 10° C. to 15° C. (2) A low-molecular-weight phase-change material is mixed with other polymers, and then is directly used as a composite of a fiber to prepare a thermal storage thermostat fiber through solution or melt composite spinning, for example, a technology for preparing a thermo-regulated fiber with a mixture of a normal-paraffin and polyethylene and ethylene-propylene copolymer as the core composition of a fiber and polypropylene as the sheath composite of a fiber through melt bicomponent spinning, as disclosed by the applicant (see Indian Journal of Fiber & Textile Research, 2003, 28(3): 265-269). However, as normal paraffins (n-CₙH₂ₙ₊₂, n=14 to 40) are small molecule compounds, existing in the core composite of the fiber in the form of blends, when in use migration from the fiber easily occurs. The normal paraffins easily migrate in use. (3) A polymeric phase-change material is used as a component of a fiber to prepare a thermo-regulated fiber by adopting a composite spinning technology, for example, a method for preparing a fiber having thermo-regulating functions by using a polymer such as an aliphatic polyether, an aliphatic polyester, and a polyester-ether as a main ingredient of a core or a sea-island composite of a fiber and a fiber-forming polymer as a sheath composite or sea composite through melt composite spinning disclosed in Chinese Patent Application No. CN1165877A of the applicant of the present invention. The method not only significantly reduces the difficulty of the process, but also realizes high-efficient production of a thermo-regulated fiber; moreover, the resulting thermo-regulated fiber has no super-cooling crystallization. However, there are limited choices of polymeric phase-change materials suitable for such method, and it is difficult to meet the needs of different uses.

### SUMMARY

In order to overcome the shortcomings of the prior art, the present invention is to provide a novel thermo-regulated fiber and a preparation method thereof in order to solve technical problems existing in the prior art. The thermo-regulated fiber is obtained by using a new polymeric phase-change material and adopting a new fiber preparation method, and the resulting thermo-regulated fiber has good thermo-regulating properties and a good thermal stability. The preparation method of the thermo-regulated fiber has the advantages that the process is simple with wide range of application, which are beneficial to promote industrial application.

The present invention relates to a thermo-regulated fiber prepared by a polymeric phase-change material as component A and a fiber-forming polymer as a component B through a melt composite spinning, solution composite spinning or electrostatic composite spinning process, where the mass fraction of the component A in the fiber is 20% to 60%, and the mass fraction of the component B in the fiber is 80% to 40%. The thermo-regulated fiber has a composite structure, and the cross-sectional structure is an sea-island type or a concentric sheath/core type, character in that the polymeric phase-change material is a polyethylene glycol n-alkyl ether (structural formula: H(OCH₂CH₂)ₘOCₙH₂ₙ₊₁), where the repeating unit number m of the ethylene glycol is 1 to 100, the number n of carbon atoms in the n-alkyl is 11 to 30. When the thermo-regulated fiber is prepared by melt composite spinning process, the fiber-forming polymer includes at least one of a copolyester, a copolyamide, polyethylene, polypropylene, poly-4-methylpentene-1, acrylonitrile-crotononitrile copolymer, acrylonitrile acrylate copolymer, and polycaprolactam; and when the thermo-regulated fiber is prepared by solution composite spinning or solution electrostatic composite spinning process, the fiber-forming polymer includes at least one of polyacrylonitrile, acrylonitrile-vinylidene chloride copolymer, and acrylonitrile-vinyl chloride copolymer. The heat absorption temperature and the heat release temperature of the fiber are in the range of 11.9° C. to 53.8° C., the heat storage capacity is 18 to 55 J/g, and the 5% weight-loss temperature is 203° C. and more.

The present invention further relates to a preparation method of a thermo-regulated fiber. The preparation method adopts the components and structure of the thermo-regulated fiber disclosed in the present invention, and one of the following processes:

(1) A melt composite spinning process: a polymeric phase-change material component A and a fiber-forming polymer component B having a moisture content of 50 to 150 ppm are respectively extruded by a single screw extruder or twin screw extruder at 180° C. to 250° C. after being melted and enter into a metering pump. The polymeric phase-change material component A and the fiber-forming polymer component B are respectively delivered to a composite spinning assembly of which the temperature is set at 180° C. to 250° C. through a connecting conduit, and compounded after passing through a filter screen and a distributing plate respectively. Spinning threads are formed by a spinneret, cooled by the air, and collected after being wound or directly collected without being wound, to obtain an as-spun fiber. The as-spun fiber is processed by conventional fiber processing method such as drawing, molding, curling or twisting, to produce a thermo-regulated filament, or is further processed to obtain a thermo-regulated staple fiber. The spinneret is a sea-island type or a concentric sheath/core type.

(2) Solution composite spinning process: a polymeric phase-change material component A having a moisture content of 50 to 150 ppm is melted and degassed in a polymerizer. A fiber-forming polymer component B having a moisture content of 50 to 150 ppm is dissolved in a solvent in a polymerizer, to obtain a solution in which the mass fraction of the polymer is 10% to 30%, and the solution is degassed. The melted polymeric phase-change material component A and the solution are respectively delivered to a metering pump, and then sent into a composite spinning assembly of which the temperature is set at 50° C. to 80° C. through a connecting conduit, and compounded after passing through a filter screen and a distributing plate respectively. Spinning threads are formed by a spinneret. The spinning threads are coagulated in a coagulation bath or spinning tunnel, and drawn, dried and molded, to obtain a thermo-regulated staple fiber or filament. The solvent is dimethyl sulfoxide, N,N-dimethylformamide (DMF) or N,N-dimethylacetamide (DMAc). The spinneret is a sea-island type or a concentric sheath/core type.

(3) Electrostatic solution composite spinning process: a polymeric phase-change material component A having a moisture content of 50 to 150 ppm is melted and degassed in a polymerizer. A fiber-forming polymer component B having a moisture content of 50 to 150 ppm is dissolved in a polymerizer, to obtain a solution in which the mass fraction of the polymer is 10% to 30%, and the solution is degassed. The melted polymeric phase-change material component A and the solution are respectively sent to a metering pump, then sent to a composite spinning assembly of which the temperature is set at 50° C. to 80° C. through a connecting conduit, and compounded after passing through a filter screen and a distributing plate respectively. Spinning threads are formed by a spinneret. The threads are drawn under a high-voltage electric field of 10 to 60 kV, to form a fiber net on a collecting plate or fiber bundles on a collecting wheel. The solvent is dimethyl sulfoxide, DMF or DMAc. The spinneret is a sea-island type or a concentric sheath/core type.

As to compare with the prior art, the present invention is characterized as follows: (1) In the thermo-regulated fiber, a new polymeric phase-change material polyethylene glycol n-alkyl ether is used, in which the polyethylene glycol block and the n-alkyl may undergo a solid-liquid phase change and a liquid-solid phase change, such that the fiber has the function of heat absorption or heat release. (2) Component A of the thermo-regulated fiber may form a continuous crystallization region, so that the fiber can release heat in a concentrated manner, which enhances the thermo-regulating function. (3) The thermo-regulated fiber can be prepared in various forms by many preparation methods such as melt composite spinning, solution composite spinning and solution static composite spinning, having a wide range of application.

### BRIEF DESCRIPTION OF THE DRAWINGS

No drawings.

### DETAILED DESCRIPTION

The present invention is further described below with reference to the following embodiments.

The present invention relates to a thermo-regulated fiber (referred to fiber for short) comprising, a polymeric phase-change material as component A, a fiber-forming polymer as component B, where the mass fraction of the component A in the fiber is 20% to 60%, and the mass fraction of the component B in the fiber is 80% to 40%. The fiber is prepared by melt spinning, solution spinning or solution electrostatic composite spinning process. The thermo-regulated fiber is in a composite structure having a sea-island type or a concentric sheath/core type of cross-sectional structure, characterized in that the polymeric phase-change material is a polyethylene glycol n-alkyl ether, the polyethylene glycol block and the n-alkyl may undergo a solid-liquid phase change and a liquid-solid phase change, where the lengths of the polyethylene glycol block and the n-alkyl are changed respectively, thereby obtaining polymeric phase-change materials with different heat absorption temperatures and heat release temperatures. The fiber-forming polymer component B includes at least one of a copolyester, a copolyamide, polyethylene, polypropylene, poly-4-methylpentene-1, acrylonitrile-crotononitrile copolymer, acrylonitrile-methyl acrylate, acrylonitrile-crotononitrile copolymer, polycaprolactam, polyacrylonitrile, acrylonitrile-vinylidene chloride copolymer, and acrylonitrile-vinyl chloride copolymer.

The polymeric phase-change material used in the fiber of the present invention is a special block polymer, includes a polyethylene glycol block and n-alkyl block. The polyethylene glycol block and the n-alkyl may be crystallizable separately or no crystallizable, depending on the length of the block. The polyethylene glycol n-alkyl ether (structural formula: H(OCH₂CH₂)ₘOCₙH₂ₙ+₁) of the present invention, the number m of repeating unit of the ethylene glycol is 1 to 100, and preferably 2 to 20, and the number n of carbon atoms in the n-alkyl is 11 to 30, and preferably 12 to 25, in which, n-alkyl may be crystallizable, while the polyethylene glycol block is not crystallizable, and plays a role to adjust the phase change property of the polymeric phase-change material. When is n is fixed and m is increased, the phase change temperature and the enthalpy of the polymeric phase-change material are first increased, and then decreased after reaching a maximum value (see Table 1).

TABLE 1
Phase change properties and thermal stabilities
of several polyethylene glycol n-alkyl ethers

| Number of | | | Crystalli- | | 5% Weight- |
|---|---|---|---|---|---|
| Polyethyl- | Number of | | zation | | loss |
| ene Glycol | Carbon | Melting | Temper- | | Temper- |
| Repeating | Atoms in | point | ature | Enthalpy | ature |
| Unit (m) | n-Alkyl (n) | (° C.) | (° C.) | (J/g) | (° C.) |
| 16 | 1 | 31.2 | 11.9 | 110 | |
| 21 | 1 | 44.6 | 25.2 | 117 | |
| 2 | 16 | 42.4 | 23.5 | 110 | 269 |
| 10 | 16 | 45.9 | 24.7 | 138 | 369 |
| 20 | 16 | 47.7 | 24.6 | 160 | 385 |
| 2 | 18 | 51.7 | 36.5 | 127 | 273 |
| 10 | 18 | 44.7 | 32.1 | 123 | 375 |
| 20 | 18 | 47.4 | 21.8 | 160 | 379 |
| 100 | 18 | 60.1 | 34.1 | 165 | 380 |

The mass fraction of the component A in the fiber of the present invention is 20% to 60%, the mass fraction of the component B in the fiber is 80% to 40%, the mass fractions of the component A and the component B are summed up to 100%. When the mass fraction of the component A in the fiber is lower than 20%, the spinning process can be easily implemented, but the heat storage capacity of the resulting fiber is low, and the thermo-regulated efficacy is poor; and when the mass fraction of the component A is higher than 60%, as the fiber-forming performance of the component A is lower than that of the component B, it is difficult to implement the spinning process readily, which consequently affects the functional performance of the fiber, and is not recommended.

The fiber-forming polymer component B in the fiber of the present invention includes at least one of copolyester, copolyamide, polyethylene, polypropylene, poly-4-methylpentene-1, acrylonitrile-crotononitrile copolymer, acrylonitrile-methyl acrylate copolymer, acrylonitrile-crotononitrile copolymer, polycaprolactam, polyacrylonitrile, acrylonitrile-vinylidene chloride copolymer, and acrylonitrile-vinyl chloride copolymer. The decomposition temperature of a copolyester, a copolyamide, polyethylene, polypropylene, poly-4-methylpentene-1, acrylonitrile-methyl acrylate copolymer, acrylonitrile-crotononitrile copolymer and polycaprolactam is higher than the melting temperature, so the polymers can be used or is suitable for melt spinning process; while the decomposition temperature of polyacrylonitrile, acrylonitrile-vinylidene chloride copolymer, and acrylonitrile-vinyl chloride copolymer is lower than the melting temperature generally, such polymers can merely be used or is suitable for solution spinning process, or is used in the electrostatic composite spinning process or process in the form of a polymer solution.

The solvent used in the present invention includes dimethyl sulfoxide, N,N-dimethylformamide and N,N-dimethylacetamide, provided that it can dissolve polyacrylonitrile, acrylonitrile-vinylidene chloride copolymer, and acrylonitrile-vinyl chloride copolymer to form a uniform spinning solution. In a wet spinning procedure, the coagulation bath is a solvent containing 10% to 60% by mass of water. The tunnel in the dry spinning process is a conduit of which the temperature is controlled at 120° C. to 200° C., where the solvent in the spinning thread is evaporated and recycled, so as to form a fiber.

The fiber of the present invention has different cross-sectional structure shapes, including a sea-island type and concentric sheath/core type, which are composite structures. The composite structure has a coating layer as an outer layer being made of component B, and a component A is encapsulated within an inner layer, so that it presents the polymeric phase-change material component A from leaking when the fiber is in use. The thermo-regulated fiber of the present invention may be in various forms such as staple, filaments, fiber mats and fiber bundles.

The present invention also relates to a preparation method of the fiber suitable for melt composite spinning, solution composite spinning or solution electrostatic composite spinning process. Specifically, according to the component and structural design of the fiber of the present invention, one of the following processes is adopted:

(1) Melt Composite Spinning Process:

(a) The polymeric phase-change material component A, namely, a polyethylene glycol n-alkyl ether is dried to remove the moisture, until the water content is lowered to 50 to 150 ppm.

(b) The polyethylene glycol n-alkyl ether is melted by conventional process, and then is sent to a metering pump of the component A of the fiber, where controls of the component A in the fiber 20% to 60% by mass.

(c) The fiber-forming polymer component B is dried to remove the moisture by a conventional process until the water moisture content is lowered to 50 to 150 ppm.

(d) The fiber-forming polymer ingredient B is melted by conventional process, and then sent to a metering pump of the component B of the fiber, where controls the component B in the fiber 80% to 40% by mass.

(e) The component A and component B are extruded by a sea-island type or a concentric sheath/core type composite spinneret, to form spinning threads.

(f) Conventional processes such as spinning threads cooling, drawing, twisting and texturing are carried out on the spinning threads to obtain thermo-regulated filaments having different specifications, or conventional processes such as collecting, drawing, curling are carried out on the spinning threads, drying and molding, and cutting, to obtain thermo-regulated staple fibers having different specifications.

(2) Solution Composite Spinning Process:

(a) The polymeric phase-change material component A, namely, a polyethylene glycol n-alkyl ether is dried to remove the moisture, until the water content is lowered to 50 to 150 ppm.

(b) The polyethylene glycol n-alkyl ether is melted by conventional process, and then is sent to a metering pump of the component A of the fiber, where controls the component A in the fiber 20% to 60% by mass.

(c) The fiber-forming polymer component B is dried to remove the moisture by conventional process, and the moisture content is lowered to 50 to 150 ppm.

(d) The fiber-forming polymer component B is dissolved by conventional process, to obtain a solution in which the mass fraction of the polymer is 10% to 30%, and then the solution is degassed and sent to a metering pump of the component B of the fiber, where the mass fraction of the component B in the product fiber is controlled at 80% to 40%.

(e) The component A and component B are extruded by a sea-island type or a concentric sheath/core type composite spinneret of which the temperature is controlled at 50° C. to 80° C., to form spinning threads; and then the spinning threads are coagulated in a coagulation bath or a spinning tunnel.

(g) Conventional processes such as cooling and drawing are carried out to process the fiber so as to obtain thermo-regulated filament of different specifications, or conventional processes such as collecting, drawing, drying and molding, and cutting, are carried out to obtain a thermo-regulated staple fiber of different specifications.

(3) Solution Electrostatic Composite Spinning Process:

(a) The polymeric phase-change material component A, namely, a polyethylene glycol n-alkyl ether is dried to remove the moisture, and the moisture content is lowered to 50 to 150 ppm.

(b) The polyethylene glycol n-alkyl ether is melted by conventional process, and then is sent to a metering pump of the component A of the fiber, where the mass fraction of the component A in the fiber is 20% to 60%.

(c) The fiber-forming polymer component B is dried to remove the moisture by conventional process, and the moisture content is lowered to 50 to 150 ppm.

(d) The fiber-forming polymer component B is dissolved by conventional process, to obtain a solution in which the mass content of the polymer is 10% to 30%; and then the solution is degassed and sent to a metering pump of the component B of the fiber, where the mass fraction of the component B in the product fiber is 80% to 40%.

(e) The component A and the component B are extruded by a sea-island type or a concentric sheath/core type composite spinneret of which the temperature is controlled at 50° C. to 80° C., to form spinning threads in an electric field of 10 to 60 kV, and then the solvent is evaporated, to form a fiber.

(g) A thermo-regulated fiber non-woven fabric is obtained by using a flat plate collector, and thermo-regulated fiber bundles are obtained by using a rotating wheel-shaped collector, which are twisted and used to fabricate a fabric.

Unless otherwise stated, the properties of the thermo-regulated fiber of the present invention are characterized by using the following devices and methods: using NETZSCH DSC 200F3, in a nitrogen atmosphere, a DSC scanning curve of a 10° C./min heating process is tested, and a DSC scanning curve of a −10° C./min cooling process is tested, to detect the heat absorption and heat release performance and the heat absorption and heat release capacity of the fiber. The thermal decomposition temperature of the fiber in the air is detected by using NETZSCH STA409 PC/PG TG-DTA at a heating rate of 10° C./min. The heat absorption temperature and the heat release temperature of the fiber obtained by the preparation method of the present invention are in the range of 11.9° C. to 53.8° C., the heat storage capacity is 18 to 55 J/g, and the 5% weight-loss temperature is 203° C. or more.

The fiber of the present invention is processed alone, or is blended with a natural fibers or chemical fiber and processed, into a thermo-regulated fabric such as clothing, bedding, shoes lining, socks and thermal insulation materials by adopting a conventional or non-conventional process. The thermo-regulated fabric absorbs heat when the ambient temperature is higher than the melting temperature of the component A of the fiber, and undergoes a solid-to-liquid phase change, so that the inner temperature of the fabric is substantially maintained unchanged. On the contrary, when the ambient temperature is lower than the crystallization temperature of the component A of the fiber, the thermo-regulated fabric undergoes a liquid-to-solid phase change, and releases heat, so that the inner temperature of the fabric is substantially maintained unchanged, thereby significantly improving the wearing comfort of the fabric.

The content of the present invention that is not described herein can apply the prior art.

Specific embodiments of the present invention are described below: the embodiments are merely intended to further describe the present invention in detail, but not to limit the scope of the present invention.

### EMBODIMENT 1

A polyethylene glycol n-hexadecyl ether (where m=2, and n=16) was used as a component A of a fiber, and an acrylonitrile-methyl acrylate (at a molar ratio of 85/15) copolymer (a number average molecular weight of 36,000) was used as a component B of a fiber. The two ingredients were dried to a moisture content of lower than 150 ppm, and the mass ratio of A to B was controlled to be 40:60. At 210° C., a sea-island type as-spun filament was produced through melt composite spinning, drawn, curled and molded, and then cut into a staple fiber.

The titer of the product fiber was 3.8 dtex, the tensile strength at break was 2.7 cN/dtex, the elongation at break was 31%; the heat absorption temperature of the fiber was 42.3° C., the heat absorption capacity was 37 J/g, the heat release temperature was 24.5° C., the heat release capacity was 38 J/g; and the 5% weight-loss temperature was 265° C.

### EMBODIMENT 2

A polyethylene glycol n-hexadecyl ether (where m=20, and n=16) was used as a component A of a fiber, and poly-4-methylpentene-1 (a number average molecular weight of 210,000) was used as a component B of a fiber. The two components were dried to a moisture content of lower than 150 ppm, and the mass ratio of A to B was controlled to be 60:40. At 230° C., a concentric sheath/core type as-spun filament was produced through melt composite spinning, drawn, curled and molded, and then cut into a staple fiber.

The titer of the product fiber was 5.1 dtex, the tensile strength at break was 2.2 cN/dtex, the elongation at break was 28%; the heat absorption temperature of the fiber was 47.3° C., the heat absorption capacity was 54 J/g, the heat release temperature was 31.3° C., the heat release capacity was 55 J/g; and the 5% weight-loss temperature was 215° C.

### EMBODIMENT 3

A polyethylene glycol n-hexadecyl ether (where m=10, and n=16) was used as a component A of a fiber, and an acrylonitrile-vinylidene chloride (at a molar ratio of 85/15) copolymer (a number average molecular weight of 32,000) was used as a component B of a fiber. The two components were dried to a moisture content of lower than 150 ppm, and the component B was dissolved in DMAc, to obtain a solution having a mass concentration of 30%. The mass ratio of A to B was controlled to be 40:60. At 70° C., a concentric sheath/core type as-spun filament was produced through solution composite spinning, and washed with water, drawn, dried and molded, and then cut into a staple fiber.

The titer of the product fiber was 3.2 dtex, the tensile strength at break was 2.3 cN/dtex, the elongation at break was 28%; the heat absorption temperature of the fiber was 43.8° C., the heat absorption capacity was 41 J/g, the heat release temperature was 25.6° C., the heat release capacity was 42 J/g; and the 5% weight-loss temperature was 203° C.

### EMBODIMENT 4

A polyethylene glycol n-octadecyl ether (where m=20, and n=18) was used as a component A of a fiber, and an acrylonitrile (a number average molecular weight of 34,000) was used as an ingredient B of a fiber. The ingredient B was dissolved in DMF, to obtain a solution having a mass concentration of 10%. The two ingredients were dried to a moisture content of lower than 110 ppm, and the mass ratio of A to B was controlled to be 30:70. At 60° C., a fiber having a concentric sheath/core type cross section is obtained by adopting a solution static composite spinning process, and then a product fiber was collected by using a flat plate collector.

The diameter range of the monofilament of the product fiber was 200 to 1,500 nm; the heat absorption temperature of the fiber was 47.3° C., the heat absorption capacity was 38 J/g, the heat release temperature was 27.6° C., the heat release capacity was 39 J/g; and the 5% weight-loss temperature was 255° C.

### EMBODIMENT 5

A polyethylene glycol n-octadecyl ether (where m=2, and n=18) was used as an ingredient A of a fiber, and an acrylonitrile-vinyl chloride (at a molar ratio of 83/17) copolymer (a number average molecular weight of 34,000) was used as an ingredient B of a fiber. The ingredient B was dissolved in DMAc, to obtain a solution having a mass concentration of 20%. The two ingredients were dried to a moisture content of lower than 110 ppm, and the mass ratio of A to B was controlled to be 20:80. At 80° C., a sea-island type fiber was produced by adopting a solution static composite spinning process, where the voltage of the electric field was 25 kV, and the fiber was collected by a wheel-shaped collector having a diameter of 50 cm.

The diameter range of the monofilament of the fiber bundles was 280 to 1,200 nm; the heat absorption temperature of the fiber was 51.3° C., the heat absorption capacity was 18 J/g, the heat release temperature was 32.6° C., the heat release capacity was 19 J/g; and the 5% weight-loss temperature was 213° C.

### EMBODIMENT 6

A polyethylene glycol n-hexadecyl ether (where m=10, and n=16) was used as a component A of a fiber, and a polyethylene terephthalate-polyethylene glycol (at a molar ratio of 70/30) copolymer (having an intrinsic viscosity of 0.68) was used as a component B of a fiber. The two components were dried to a moisture content of lower than 120 ppm, and the mass ratio of A to B was controlled to be 30:70. At 220° C., a sea-island type as-spun filament was produced by adopting a melt composite spinning process, and then drawn and twisted, to obtain a filament fiber.

The titer of the product fiber was 140 dtex/48 f, the tensile strength at break was 2.5 cN/dtex, the elongation at break was 36%; the heat absorption temperature of the fiber was 42.5° C., the heat absorption capacity was 27 J/g, the heat release temperature was 24.1° C., the heat release capacity was 28 J/g; and the 5% weight-loss temperature was 254° C.

### EMBODIMENT 7

A polyethylene glycol n-tetradecyl ether (where m=20, and n=14) was used as a component A of a fiber, and a polycaprolactam-polyethylene glycol (at a molar ratio of 80/20) copolymer (having an intrinsic viscosity of 0.69) was used as a component B of a fiber. The two components were dried to a moisture content of lower than 150 ppm, and the mass ratio of A to B was controlled to be 30:70. At 220° C., a concentric sheath/core type as-spun filament was produced by adopting a melt composite spinning process, and drawn, curled and molded, and then cut into a staple fiber.

The titer of the product fiber was 3.1 dtex, the tensile strength at break was 2.9 cN/dtex, the elongation at break was 38%; the heat absorption temperature of the fiber was 32.1 ° C., the heat absorption capacity was 24 J/g, the heat release temperature was 20.3° C., the heat release capacity was 25 J/g; and the 5% weight-loss temperature was 208° C.

### EMBODIMENT 8

A polyethylene glycol n-eicosyl ether (where m=10, and n=20) was used as a component A of a fiber, and an acrylonitrile-vinylidene chloride (at a molar ratio of 70/30) copolymer (a number average molecular weight of 32,000) was used as a component B of a fiber. The two components were dried to a moisture content of lower than 150 ppm, and the ingredient B was dissolved in dimethyl sulfoxide, to obtain a solution having a mass concentration of 26%. The mass ratio of A to B was controlled to be 40:60. At 50° C., a sea-island type as-spun filament was produced through solution composite spinning, and drawn and twisted, to obtain a filament fiber.

The titer of the product fiber was 125 dtex/48 f, the tensile strength at break was 2.7 cN/dtex, the elongation at break was 30%; the heat absorption temperature of the fiber was 53.8° C., the heat absorption capacity was 34 J/g, the heat release temperature was 35.6° C., the heat release capacity was 32 J/g; and the 5% weight-loss temperature was 208° C.

### EMBODIMENT 9

A polyethylene glycol n-eicosyl ether (where m=20, and n=12) was used as a component A of a fiber, and an acrylonitrile-vinylidene chloride (at a molar ratio of 85/15) copolymer (a number average molecular weight of 32,000) was used as a component B of a fiber. The two components were dried to a moisture content of lower than 150 ppm, and the ingredient B was dissolved in DMAc, to obtain a solution having a mass concentration of 26%. The mass ratio of A to B was controlled to be 40: 60. At 60° C., a sea-island type as-spun filament was produced through solution composite spinning, and drawn and twisted, to obtain a filament fiber. The resulting fiber has a significant heat absorption and release capacities and an enhanced thermal stability.

### EMBODIMENT 10

A polyethylene glycol n-pentacosyl ether (where m=10, and n=25) was used as an ingredient A of a fiber, and an acrylonitrile-vinyl chloride (at a molar ratio of 85/15) copolymer (a number average molecular weight of 32,000) was used as an ingredient B of a fiber. The two ingredients were dried to a moisture content of lower than 150 ppm, and the ingredient B was dissolved in DMF, to obtain a solution having a mass concentration of 26%. The mass ratio of A to B was controlled to be 40:60. At 70° C., a sea-island type as-spun filament was produced through solution composite spinning, drawn and twisted, to obtain a filament fiber. The resulting fiber has a significant heat absorption and release capabilities and an enhanced thermal stability.

The present invention has been disclosed above through specific embodiments, but persons of ordinary skill in the art should understand that various variations and equivalent replacements may be made without departing from the scope of the present invention. Additionally, in order to be adapted to specific situations or materials in the technology of the present invention, various modifications may be made without departing from the protection scope of the present invention, which shall fall within the embodiments of the protection scope as defined by the appended claims.

What is claimed is:

1. A thermo-regulated fiber, comprising a polymeric phase-change material as an ingredient A and a fiber-forming polymer as an ingredient B, wherein the mass fraction of the ingredient A in the fiber is 20% to 60%, the mass fraction of the ingredient B in the fiber is 80% to 40%, and the fiber is prepared by a melt composite spinning, solution composite spinning or solution static composite spinning process, the thermo-regulated fiber has a composite structure, the cross-sectional structure is a sea-island type or a concentric sheath/core type, characterized in that the polymeric phase-change material is a polyethylene glycol n-alkyl ether, wherein the number m of the ethylene glycol repeating unit is 1 to 100, the number n of carbon atoms in the n-alkyl is 11 to 30; when the thermo-regulated fiber is prepared by adopting a melt composite spinning process, the fiber-forming polymer comprises at least one of a copolyester, a copolyamide, polyethylene, polypropylene, poly-4-methylpentene-1, acrylonitrile-methyl acrylate copolymer, acrylonitrile-crotononitrile copolymer and polycaprolactam; when the thermo-regulated fiber is prepared by adopting a solution composite spinning or solution static composite spinning process, the fiber-forming polymer comprises at least one of acrylonitrile, acrylonitrile-vinylidene chloride copolymer, and acrylonitrile-vinyl chloride copolymer; the heat absorption temperature and the heat release temperature of fiber are in the range of 11.9° C. to 53.8° C., the heat storage capacity is 18 to 55 J/g, and the 5% weight-loss temperature is 203° C. and more.

2. The thermo-regulated fiber according to claim 1, wherein the number m of the ethylene glycol repeating unit is 2 to 20, the number n of carbon atoms in the n-alkyl is 12 to 25.

3. A method for preparing the thermo-regulated fiber according to claim 1 by adopting a melt composite spinning process, comprising:
respectively extruding a polymeric phase-change material component A and a fiber-forming polymer component B having a moisture content of 50 to 150 ppm by a single screw extruder or twin screw extruder at 180° C. to 250° C. after being melted, and entering a metering pump; sending the polymeric phase-change material component A and the fiber-forming polymer component B into a composite spinning assembly of which the temperature is set at 180° C. to 250° C. through a connecting conduit; compounding after passing through a filter screen and a distributing plate respectively; forming spinning threads by a spinneret, cooling by the air, and collecting after being wound or directly collecting without being wound, to obtain an as-spun fiber; processing the as-spun fiber by process such as drawing, molding, curling or twisting, to obtain a thermo-regulated filament, or further processing the as-spun fiber, to obtain a thermo-regulated staple fiber, wherein the spinneret is a sea-island type or a concentric sheath/core type.

4. A method for preparing the thermo-regulated fiber according to claim 1 by adopting a solution composite spinning process, comprising:
melting and degassing a polymeric phase-change material ingredient A having a moisture content of 50 to 150 ppm in a polymerizer, and dissolving a fiber-forming polymer ingredient B having a moisture content of 50 to 150 ppm in a solvent in a polymerizer, to obtain a solution in which the mass fraction of the polymer is 10% to 30%, and degassing the solution; respectively sending the melted polymeric phase-change material ingredient A and the solution into a metering pump, and then sending into a composite spinning assembly of which the temperature is set at 50° C. to 80° C. through a connecting conduit; compounding after passing through a filter screen and a distributing plate respectively, and forming spinning threads by a spinneret; coagulating the spinning threads in a coagulation bath or spinning tunnel, and drawing, drying and molding, to obtain a thermo-regulated staple fiber or filament; the solvent is dimethyl sulfoxide, N,N-dimethylformamide or N,N-dimethylacetamide; and the spinneret is a sea-island type or a concentric sheath/core type.

5. A method for preparing the thermo-regulated fiber according to claim 1 by adopting a solution static composite spinning process, comprising:
melting and degassing a polymeric phase-change material ingredient A having a moisture content of 50 to 150 ppm in a polymerizer, and dissolving a fiber-forming polymer ingredient B having a moisture content of 50 to 150 ppm in a solvent in a polymerizer, to obtain a solution in which the mass fraction of the polymer is 10% to 30%, and degassing the solution; respectively sending the melted polymeric phase-change material ingredient A and the solution into a metering pump, and then sending into a composite spinning assembly of which the temperature is set at 50° C. to 80° C. through a connecting duct, and compounding after passing through a filter screen and a distributing plate respectively, and forming spinning threads by a spinneret, and drawing the threads in the presence of a high-voltage electric field of 10 to 60 kV, to form a fiber net on a collecting plate or fiber bundles on a collecting wheel; the solvent is dimethyl sulfoxide, N,N-dimethylformamide or N,N-dimethylacetamide; and the spinneret is a sea-island type or a concentric sheath/core type.
